(19) United States
(12) Patent Application Publication
(10) Pub. No.: US 2009/0038226 A1
(43) Pub. Date: Feb. 12, 2009

(54) Child safety window block

(76) Inventors: Gerald Angelo Morrone, Verona, PA (US); Louis Samuel Tedesco, Pittsburgh, PA (US)

Correspondence Address: William S. Karn, 664 Lincoln Avenue, Pittsburgh, PA, 15202-3420, US

(21) Appl. No.: 11/891,271

(22) Filed: Aug. 10, 2007

(51) Int. Cl. E05F 5/06

(52) U.S. Cl. 49/49

(57) ABSTRACT

A child safety window block consists of a block of material of which one face has a tacky adhesive. The block by the adhesive can be affixed to a window frame to limit the opening travel of the window to a ventilating gap which is too small for a child to pass out of the window. One block variation is a design with a push button switch which activates a sounder and which is reset to off by a concealed switch accessible with a narrow pointed tool. Another design incorporates a radio wireless button. The wireless receiver door bell sounder can activate any of a variety of attached security alarm features. Another variation uses a magnet or Velcro as part of the block fastening mounting.

### BACKGROUND OF THE INVENTION

1). Field of the Invention

This invention relates to exit from and entry to a room via an open window. The window block is a safety security measure.

2). Background Information

There are occasional news reports of a child exiting via an open window to fall from a dangerous height. There are occasional news reports of foreign entry via an open window with subsequent criminal action against a person within a room. The window block allows limited aperture opening of the window for ventilation while blocking passage of a person. The block also provides for its removal from the inside in a situation of fire impelled quick escape.

### PRIOR ART

Prior art is plentiful and is such as listed in U.S. Pat. No. 5,552,768 of inventors Mikiel and Usevitch. The Mikiel invention has its friction blocking force generated by a force vector exerted against the window glass, generated by a wedging action. The device has a suction cup for holding the wedge in position on the glass. One version of the present invention petition for letters patent does not place the block on the glass. The block is held by adhesive on the window frame.

Another product on the market also uses a wedge but that product designs around the Mikiel patent. The design around product is a wedge with adhesive and no suction cup. Moreover, the wedge is mounted, not on the glass, but on the frame of the upper sash. That product may be viewed with photograph, description, sale price, and user comments on a web site path defined as follows: “http://www.onestepahead.com//product/85216/127764/117.html”.

The present application for a patent has adhesive but no wedge. The present invention has a sounder but no suction cup.

Prior art also includes U.S. Pat. No. 6,778,086 of title “Open Window Security Lock” by same inventors as petitioners for letters patent herein. In contrast to their patent 086 product defining a shaft, their present product is a small block with its elevation position defined by setting of the upper frame rather than the lower frame patent 086 setting.

### OBJECT OF INVENTION

It is therefore one object of the present invention to provide a simple, easy to use device that can block a sliding glass window in a partially open position of variable user chosen position.

Another object of the present invention is to provide an easy means for mounting the block in its operating position Another object of the present invention is to add electrical response means to a window block that has been alarm activated by movement of a window sash against the block.

Another object of the present invention is to secure limited opening capability of either the upper sash or lower sash of a double hung window.

Another object of the present invention is to permit a room occupant to quickly remove the window block in event of fire induced emergency exit action.

### BRIEF DESCRIPTION OF THE INVENTION

A purpose of the present invention is to provide a portable sliding window blocking device that is easy to transport and use. The primary incentive initiating the inventive effort was to protect children from falling out of a window. Also the block offers effective resistance to unlawful entry from the outside.

The block unit may be visualized as an elongated cube shaped box with an adhesive material on one surface (typically double adhesive side tape). The box has a push button switch, a light signaling activation, and a sounder signaling activation. A tool such as a small screw driver blade can be slipped into a small port to switch off the alarm action.

A magnet may be a link in the mechanism for holding the block into its service position. When the protected window is non-magnetic such as wood or aluminum, an intermediary ferromagnetic layer is glued to the window glass or fastened to the frame. The ferromagnetic layer holds the magnet which holds the block. Velcro can work with approximately the same functionality as a magnet in the invention. The magnet fastener sustains shear loading rather than tension loading meaning that the block can be pulled off by tension loading. The block with magnet can not slide off because of a resisting lip on the ferromagnetic layer. Velcro also has pronounced shear resistance because all micro hooks resist shear simultaneously when a Velcro patch is loaded in shear.

### BRIEF DESCRIPTION OF THE DRAWINGS

FIG. 1 is a full face view of a portable sliding window block according to the invention, viewed from the interior of the room by a viewer looking toward the outside of the window.

FIG. 2 is a full face view of the window block with a push button and sounder shown.

FIG. 3 is a long side view of a window block holding system comprising an adhesive layer and two successive layers, e.g. ferromagnetic sheet and bar magnet.

FIG. 4 portrays the adhesive layer that holds fast to the window frame or glass.

FIG. 5 shows a block bottom view with the alarm switch and adhesive layer.

FIG. 6 portrays an adhesive layer with two successive layers of snapped together Velcro.

FIG. 7 shows an assembled isometric view of an alarm block with switch and sounder.

FIG. 8 is a C-clamp design which attaches not to the sash but is clamped to the track side bar.

FIG. 8 is a block top view showing a wireless door bell button mounted on the block.

FIG. 9 is a block side view and showing how the door bell button is pressed through bending action of a thin metal strip.

FIG. 10 is an end view of an assembly of the block components.

### DETAILED DESCRIPTION OF THE INVENTION

The original inventive inspiration was to protect young children from open a ventilating window wider than was originally set by the parent and then climbing out. The means to achieve that protection as conceived by the inventor require only three substances, viz.: an adhesive, a cube, and block signal generator. On one surface of a cube is coated the adhesive (double sided sticky tape). On the opposite surface of the cube are displayed a light and a sounder.

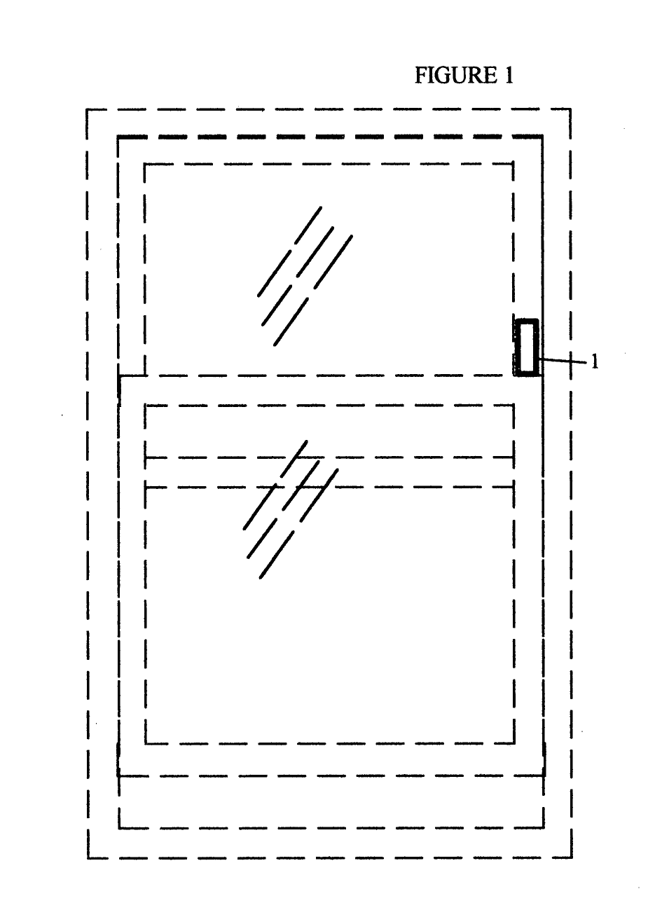

In FIG. 1 the part 1 is the block attached with adhesive to the frame of the upper sash.

When the block is mounded on the window upper sash frame the push button switch is pointed downward to intercept any effort to raise the lower sash any further than a few inches. In the event that the upper sash is of moveable design the block is carried down with a lowering sash movement. That restricts and limits the possible distance movement of either or both upper and lower sash; i.e. the mathematical sum of the two opening spaces is a fixed sum

Adhesive such as is found on double sided adhesive tape, holds the block in position on vinyl coated aluminum window frames with very good service quality, and it tenaciously resists removal by hand action.

Wooden window frames of a lesser polish surface may give mixed results. One can add a polished surface plate to the wood. Such a plate can be attached with glue, e.g. epoxy. If the attached plate is steel (ferromagnetic material) the steel provides a convenient mounting and release feature. With the mounting of an intermediate ferromagnetic layer the safety block can be attached to glass, to aluminum, to wood with ease. A sixteenth inch thick or thinner steel plate is adequate for holding fast a bar magnet. Adding a thirty-second inch high curled lip at the force resisting edge guarantees that the magnet can not be displaced in shear direction by an effort to open the window wider.

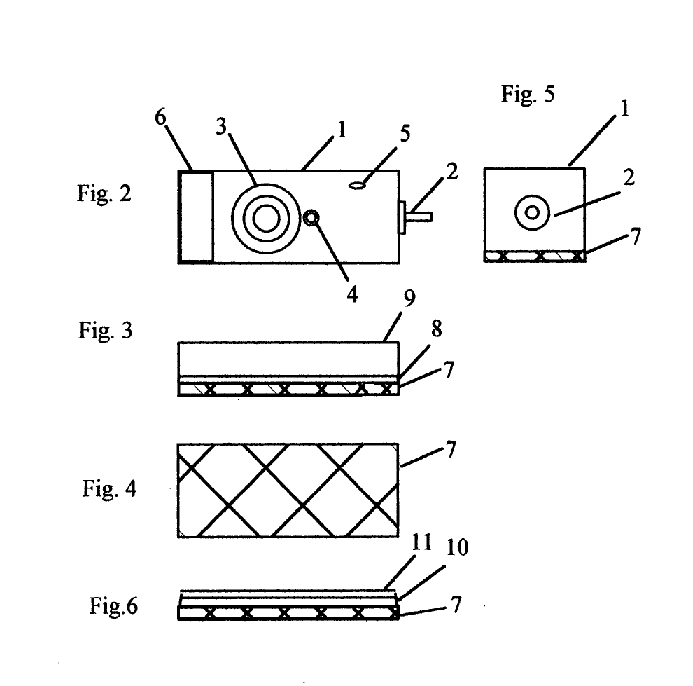

FIG. 2 shows the total block as piece 1, the push button electric switch as piece 2, the sounder as piece 3, the alarm active light as piece 4, the reset switch accessible with a small screwdriver blade as piece 5, the electric battery compartment as piece 6.

FIG. 3 shows how a bar magnet as piece 9 can hold to ferromagnetic sheet piece 8 which in turn is fastened via adhesive layer piece 7 to any window material such as aluminum, glass, or wood.

FIG. 4 shows the full adhesive layer.

FIG. 5 shows the block bottom with electric push rod switch and adhesive layer piece 7.

FIG. 6 shows piece 7 adhesive layer, Velcro layer piece 10 and matching Velcro hook layer piece 11.

Whether FIG. 3 or 4 or 6 is used to hold block piece 1 in service operation will depend upon circumstance. If there is only one window in the room and that window may be required as an emergency fire exit then the magnet or Velcro is the holding means of preference. If the room has several windows capable of being locked then the fire escape passage window should be locked with an easy manual unlock capability and the safety block is placed on another window as ventilation window and without concern as to whether the block can be quickly removed.

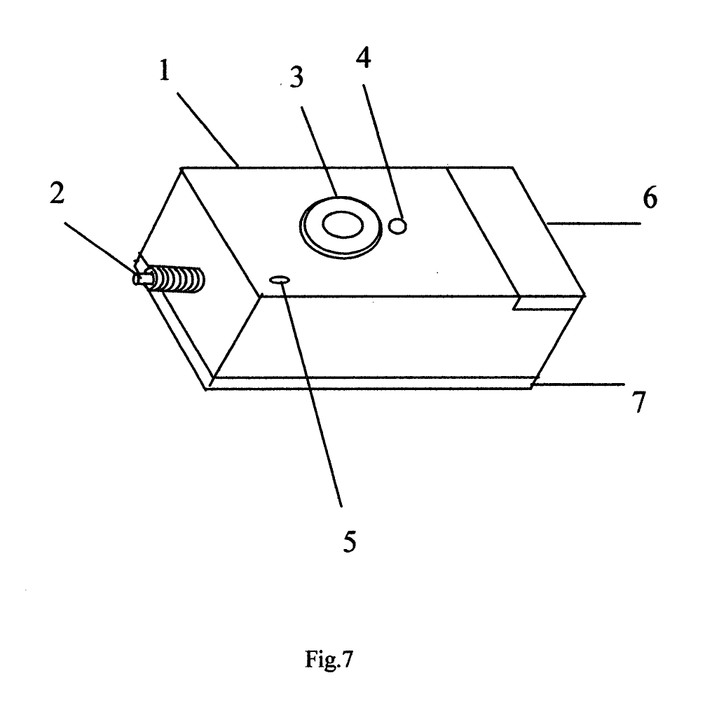

FIG. 7 is an isometric view of the block. The part numbers are as defined above. When the block is mounted for service the switch piece 3 points downward to intercept the lower window sash.

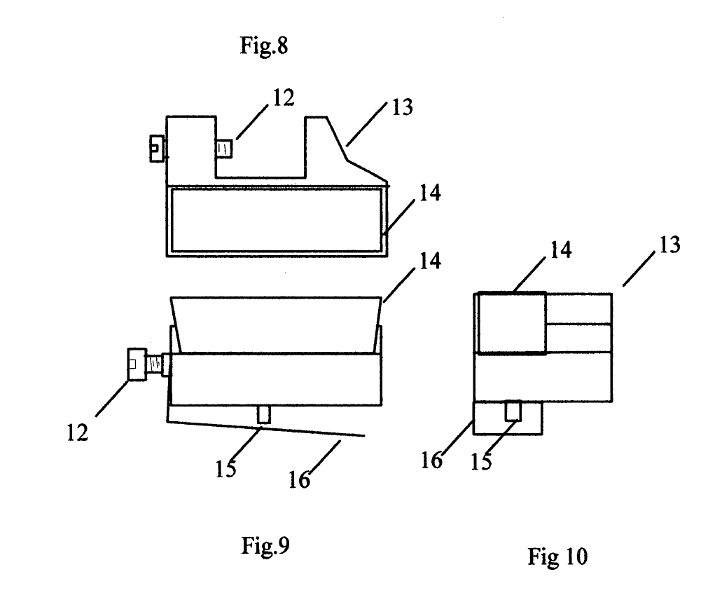

FIGS. 8, 9, and 10 show how a wireless door bell button is mounted on a window block.

Piece 12 is a screw tapped into a lip structure of piece 13 so as to permit block piece 13 to be clamped to a window frame to intercept a window sash that is being raised a few inches for ventilation.

Piece 14 is a wireless door bell button, commonly available for sale at many hardware stores. The switch button of piece 14 is pushed through the force of an intermediary pin piece 15. Piece 15 is a six penny nail sawed off at the appropriate length. Piece 16 is a strip of sheet metal of springy quality. The window sash movement bears at the end region of the strip of sheet metal. Thus when the strip is bent upward toward the wireless switch button the switch is closed but the switch can not be crushed through pin 15 movement because the sash intercepts the structure of the block piece 13. It is only the spring force of piece 16 that is transmitted to pin piece 15.

The market appeal of the product lies in its simplicity of form and low cost of installation. The appeal is to parents with small children.

The web page cited above (“onestepahead”) lists reader and user comments. One window wedge user complained that his window sash rode right over the wedge without being stopped. One may surmise that the wooden strip on the window frame which defines the track had some missing nails. The strip then bowed out allowing the lower sash to spring over the window block wedge adhesive fastened to the frame of the upper sash. In that situation a wedge is not a preferred design and the present invention would work better. Since the ferromagnetic steel plate glued to the upper window glass would measure less than one eighth thick, one can use the magnet holding system and still remove the block device and its magnet for window washing such as to allow clearance to move either sash over its full normal travel distance. This removable quality of the magnetic would not compromise the protection for a small child who is not likely to be capable of pulling loose a bar magnet. An adult escaping from a room fire can readily lift a bar magnet from its mount. The lip on the ferromagnetic mount plate still provides total shear resistance force.

A few more words about the C-clamp (shown in drawing FIG. 8) and wireless features are appropriate. The guiding principle was to minimize custom design features. The creativity lay in joining together an assembly of products already on the market. The rule was not to open equipment boxes to solder wire attachments. Only the simple assembly support was custom made of wood. On that support was mounted a wireless door bell button. The actuator for the button switch was a meritorious design. The window sash should not rigidly press against the door bell button lest it damage the button. A nail head, as a part of a push rod (sawed short 6 penny nail), pushed against the button. However that was a flexible push because the force came through a pliable sheet metal strip bridging between the sash force point (end opposite the fulcrum) and the push rod end.

The wireless receiver sounder operated when the window sash movement closed the wireless door bell button. The next sequence choice was to have a latching relay that would keep a tripped alarm operating until a reset button could be pushed. One could open the wireless receiver box and solder some connector wires. The choice was to simply position a sound operated switch in close proximity to the wireless bell. Now the easy plug-in choices are wide open. A string of blinking Christmas tree lights can be added. A dial out phone system from Radio Shack can be added, An intercom listening system can be added and activated. None of such add devices requires soldering or opening electronic package boxes. Any one, of such devices which are activated by the wireless receiver, is referenced in the claims section as a supplemental alarm responding device.

Many modern windows have mobility only in the lower sash. (Window washing is performed by a mechanism that allows the lower sash to be hinged out of its vertical track.) The single block does the job of limiting travel of the lower sash.

When the invention is installed in a double hung window where both sashes are moveable some mechanism is needed to immobilize the upper wooden sash if the C-clamp design is used. Many of such old windows had counterweights and sash cords. If the intruding person on the outside of the window were to push the top sash down it would still be difficult to climb over the obstacle of the two sashes together. Moreover, there is an easy way to immobilize the upper sash. A wood screw will do the job. A gypsum board dry wall screw was placed at the top of the window between the wooden sash frame and the fixed wooden cross member.

The adhesive block attached to the upper sash would seem to be adequate alone since lowering the upper sash would cause the block to push closed the lower sash. Based upon actual experiments, the adhesive did not hold reliably on old wooden window frames. The wooden C-clamp did work with no problems. An adequately fastened adhesive held block mounted on the upper sash fully protects against excessive opening of either upper or lower sash.

The use of a magnet or Velcro as a part of the holding means inspires a break through to even greater utility. When the battery, which operates the wireless, needs an annual replacement the owner simply disengages the device at the magnet holding point and owner has an environment for easy replacement of the battery. Velcro can do the same job as a magnet,

### Analysis of the Mechanics of Mounting the Block

Window block prior art shows several stop means, viz.: a suction cup, a double face adhesive tape, a window frame structure integrated latch as possible ways to restrict window opening travel distance. The use of a magnet or Velcro for such a mounting purpose appears to be novel. The primary objective is to implement a holding force. A derivative objective is capability and ease of manipulation, e.g. removal of block to wash a window or removal of a block to replace an exhausted electric battery. Implied is a need for ease of reinstallation and a desired facility of ease of initial installation.

The use of a magnet opens up a variety of holding configurations. The magnetic field strength can be the holding force. The magnetic force may simply serve to position a hook structure such that the greater holding force comes from a mechanical attachment pattern. The magnetic force may serve to supplement a tacky adhesive holding force. The magnetic force may serve to hold a latch mechanism in place while the mounting glue or cement sets up like epoxy cement.

### Best Version Disclosed of Window Block

The window block process is primarily a resistive force with a secondary value of detection. Let us begin with evaluation of prior art to see whether there are any remaining niche values to be covered. Prior art has covered suction cup and tacky double sided adhesive tape useful for existing windows. Another prior art is a latch stop built into a new window. A screw clamp that holds to the window track edge may be found new and useful. Velcro may be found new and useful. A bar magnet shows evidence of being new and appears to be useful.

A bar magnet can be used on glass by first gluing a thin sheet steel plate to the glass. Enhanced resistance to shear movement can be achieved with a slight lip bend at the edge of the sheet steel. Also bear in mind, when removing the sensor for service, that there is the option of having the magnet permanently attached to one object (the glass) or the other object (the block) or permanently affixed to neither. The sheet steel plate has low profile that permits full movement of either sash when the sensor is removed.

Comparing a magnet with Velcro, they have similarity in installation and function. Both involve a glue bonding detail between the window glass or window frame and the block unit. Velcro has high resistance to shear movement since each thread hook holds mechanically. A magnet resists shear by a force times coefficient of friction factor, but it also has capability of utilizing a restraining lip in the attracted sheet steel plate. A bar magnet does not buckle if loaded in its plane. Velcro fabric holds in shear not by resisting buckling but by hook distribution.

The straight glue layer between block and window structure involves some compromise between glue holding (or tacky tape holding) and easy removal capability. The magnet and Velcro have no such problem

Another contender for the role of holding the block to the window is a screw clamp that grips the window frame. It is a close race with maybe Velcro being the winner of best disclosed design.

That which is claimed is:

1. A block functioning as a portable device for blocking a sliding window, said window comprising sliding lower sash and an upper sash and said portable device comprising a block of material serving as an obstruction to travel of a window sash, said block of material being held fast to the upper sash of said sliding window by gripping force of an adhesive substance and having an electric battery, having a push button switch, having an alarm sounder, and having a hidden reset switch accessible with a tool through a small aperture in the block.

2. The block functioning as a portable device of claim 1, wherein said gripping force of an adhesion substance acts through an intermediary layer of a pair of Velcro strips.

3. The block functioning as a portable device of claim 1, wherein said gripping force of an adhesion substance acts through an intermediary layer of a magnet and a ferromagnetic layer, said ferromagnetic layer having a protruding lip such that the lip prevents the magnet from sliding under shear applied force.

4. The block functioning as a portable device for blocking a sliding window, said window comprising a sliding sash and said portable device comprising a block of material serving as an obstruction to travel of a window sash, said block of material having mounted thereon a wireless door bell button such that moving the sash against the block also presses the door bell button to be electrically closed to signal a door bell sounder to sound.

5. The block functioning as a portable device for blocking a sliding window, said window comprising sliding sash and immobile window frame and said portable device comprising a block of material fashioned as a C-clamp that clamps to the immobile window frame and the block serving as an obstruction to travel of a window sash.

6. The portable device of claim 4 wherein said wireless door bell sounder activates a sound operated switch.

7. The portable device of claim 4 wherein said wireless door bell sounder activates a sound operated switch which sound operated switch in turn activates a supplemental alarm responding device.
